(19) United States
(12) Patent Application Publication
(10) Pub. No.: US 2013/0027362 A1
(43) Pub. Date: Jan. 31, 2013

(54) FINGER COVER FOR OPERATING A CAPACITIVE TOUCH PANEL AND GLOVE COMPRISING THE SAME

(71) Applicants: James LEE, Taipei (TW); Hong Hsu Huang, Taipei (TW); Chi Shu Kang, Taipei (TW); Jung-Hsiang Peng, Taipei (TW)

(72) Inventors: James LEE, Taipei (TW); Hong Hsu Huang, Taipei (TW); Chi Shu Kang, Taipei (TW); Jung-Hsiang Peng, Taipei (TW)

(73) Assignee: TEX-RAY INDUSTRIAL CO., LTD., Taipei (TW)

(21) Appl. No.: 13/309,659

(22) Filed: Dec. 2, 2011

(30) Foreign Application Priority Data
Jul. 27, 2011 (TW) 100126489

(51) Int. Cl. G06F 3/033

(52) U.S. Cl. 345/179

(57) ABSTRACT

A finger cover for operating a capacitive touch panel and a glove comprising the same are provided. The finger cover comprises a finger pulp portion and a finger back portion opposite the finger pulp portion. The finger cover is woven of a conductive yarn and is separably combined with a body to form the glove. A user who wears the glove is able to be coupled with the capacitive touch panel through the finger cover for control via touch.

This application claims the benefit of priority based on Taiwan Patent Application No. 100126489 filed on Jul. 27, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a finger cover and a glove comprising the same, and more particularly, to a finger cover capable of being coupled with and adapted to operate a capacitive touch panel and a glove comprising the same.

2. Descriptions of the Related Art

Touch panels are devices attached onto the surface of liquid crystal screens. When a finger or a touch pen slightly touches the touch panel disposed on the liquid crystal screen, the position of the pointer can be controlled through the senses to input instructions. Compared to conventional personal computers (PCs), touch panels eliminate the need of a peripheral device such as a keyboard or a mouse to input instructions, thereby saving space. Furthermore, the more intuitive operational mode thereof has gained wide popularity from users. Therefore, over recent years, touch panels have found wide applications in various fields, for example, in portable electronic products, automatic teller machines (ATMs), industrial control systems and information guiding and query machines.

Touch panels may generally be classified into the following categories depending on their sensing principles: capacitive, resistive, electromagnetic and infrared. Touch panels that operate on different principles have different power consumption levels and different touch sensitivities, resulting in respective advantages and disadvantages in application. Amongst the different touch panels, even though capacitive touch panels consume a high amount of power, they require only a slight touch to the panel body for operation; as a result, capacitive touch panels have become the most commonly used touch panels.

Capacitive touch panels perform coordinate positioning by relying on the induced current generated when the user's body is electrostatically coupled with an electric field of the touch panel, thereby resulting in a very quick reaction speed. Meanwhile, the same control effect may also be achieved when other objects capable of being electrostatically coupled with the capacitive touch panel is used to touch the capacitive touch panel. Hence, it can be readily appreciated that if an object that is unable to be electrostatically coupled with the capacitive touch panel is used by the user to touch the capacitive touch panel, no response will be obtained. In other words, because conventional gloves are unable to be electrostatically coupled with the capacitive touch panel, a user who wears such a glove in cold weather or for some other reason will be unable to give any instruction to the capacitive touch panel.

In view of this, it is important to provide a finger cover capable of being electrostatically coupled with a capacitive touch panel and a glove comprising the finger cover so that a user who wears this finger cover or the glove can still operate the capacitive touch panel.

### SUMMARY OF THE INVENTION

An objective of the present invention is to provide a finger cover that can be worn by a user on a finger thereof so that the finger is coupled with a capacitive touch panel to operate the capacitive touch panel.

Another objective of the present invention is to provide a glove which, when coming into contact with the capacitive touch panel, allows the finger to be electrostatically coupled with the capacitive touch panel so that the user can operate the capacitive touch panel.

To achieve the aforesaid objective, the finger cover of the present invention comprises a finger pulp portion and a finger back portion opposite the finger pulp portion. The finger cover is woven of a conductive yarn, and is separably combined with a body to form a glove. A user who wears the glove on the hand thereof is able to be coupled with the capacitive touch panel through the finger cover.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic front view of a first embodiment of a glove according to the present invention;

FIG. 1B is a schematic rear view of the first embodiment of the glove according to the present invention;

FIG. 2 is a schematic view of a second embodiment of the glove according to the present invention;

FIG. 3 is a schematic enlarged view of the finger cover of the first embodiment according to the present invention; and

FIG. 4 is a schematic partially enlarged view of a conductive yarn of the glove according to the present invention.

### DESCRIPTION OF THE PREFERRED EMBODIMENT

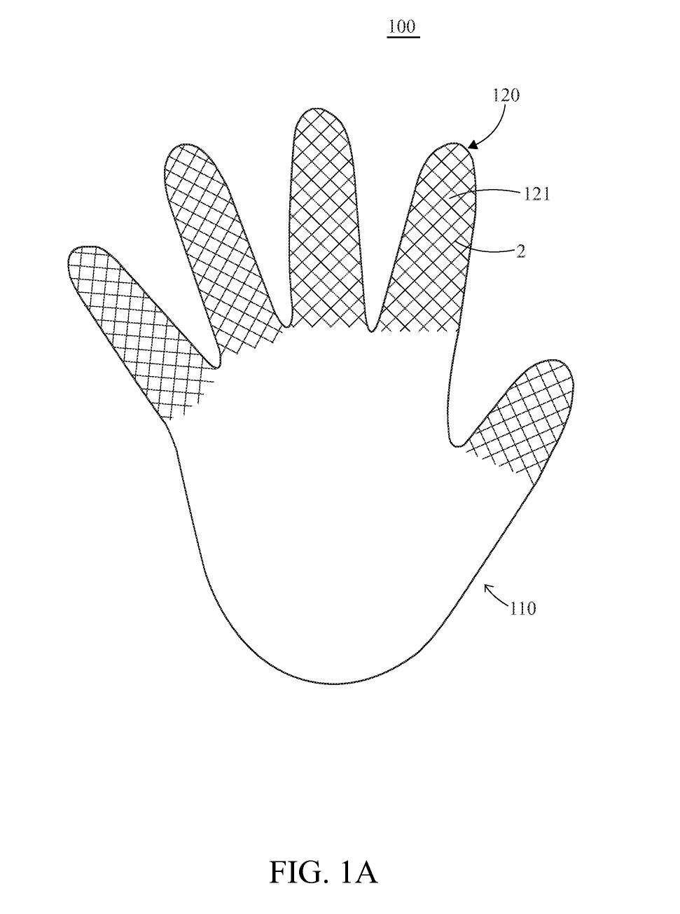

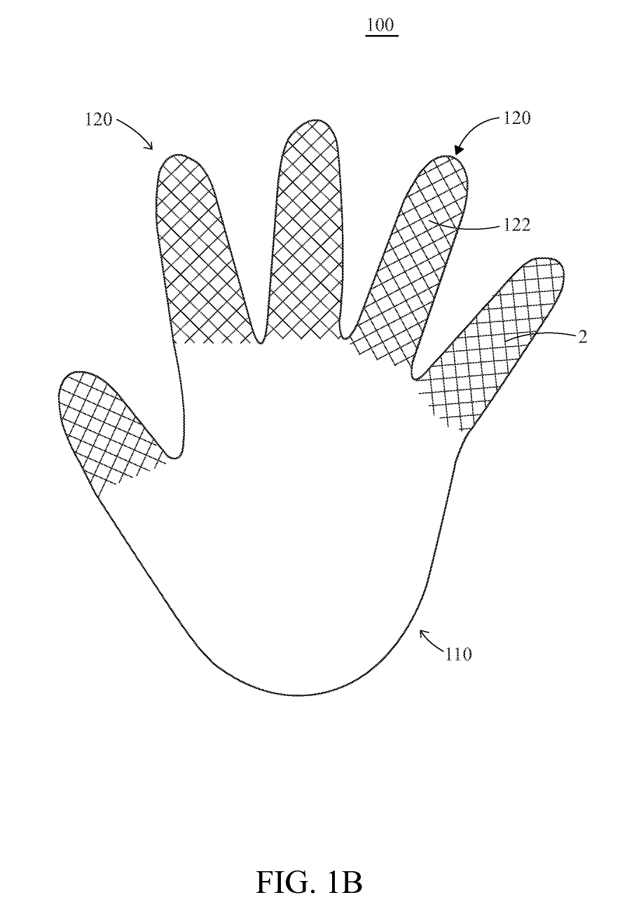

With reference to FIGS. 1A and 1B, a glove 100 that is used for operating a capacitive touch panel (not shown) according to a first embodiment of the present invention comprises a body 110 and at least one finger cover 120. In this embodiment, the finger cover 120 preferably comprises five finger covers 120, each of which comprises a finger pulp portion 121 and a finger back portion 122 opposite the finger pulp portion 121. The five finger covers 120 are separably combined with the body 110. It shall be appreciated that for the purpose of distinction in this invention, the finger pulp portion 121 refers to the portion facing towards an inner side of the user's palm and the finger back portion 122 refers to the portion facing towards an outer side of the palm.

As shown in FIG. 1A, the finger cover 120 is woven of a conductive yarn 2, and the body 110 is woven of a fabric different from the conductive yarn 2. Hence, when the user wears the glove 100 on a hand thereof, the five finger covers 120 are adapted to be worn on the user's fingers respectively so that the user is able to be coupled with the capacitive touch panel through the five finger covers 120 woven of the conductive yarn 2.

It shall be appreciated that in the first embodiment as shown in FIGS. 1A and 1B, both the finger pulp portion 121 and the finger back portion 122 of each finger cover 120 are able to be electrostatically coupled with the capacitive touch panel while the body 110 is not, because only the five finger covers 120 of the glove 100 are woven of the conductive yarn 2 while the body 110 is still woven of a conventional material different from the conductive yarn 2,

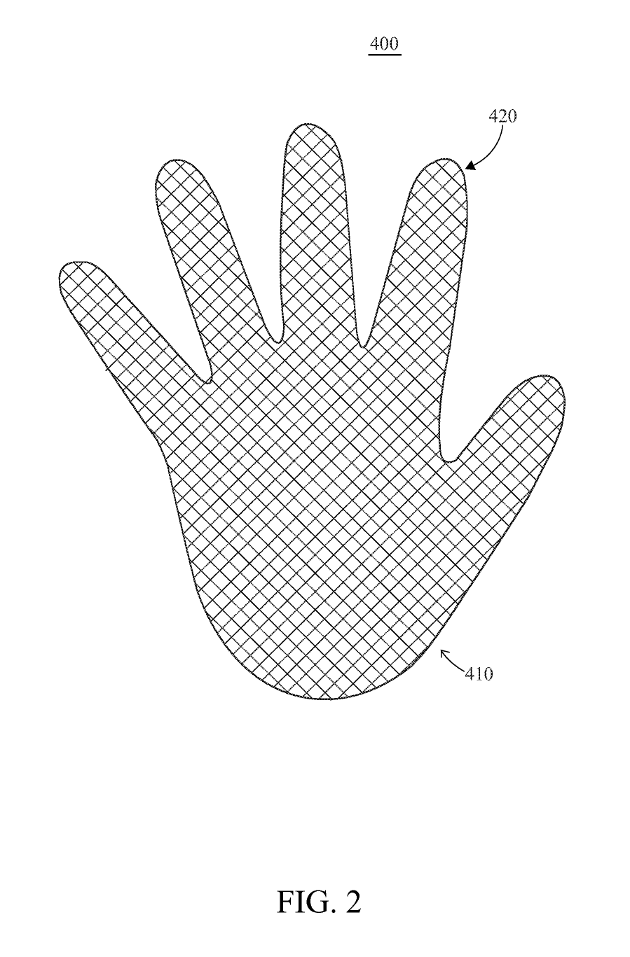

FIG. 2 shows a second embodiment of the present invention. As shown, the glove 400 comprises a body 410 and at least one finger cover 420. The finger cover 420 preferably comprises five finger covers 420. Similar to the finger covers 120 of the first embodiment, the finger cover 420 of the second embodiment may each comprise a finger pulp portion (not shown) and a finger back portion (not shown). Because the functionalities of the finger cover 420 of the second embodiment are all the same as the finger covers 120 of the first embodiment, no further description will be made thereon again. The second embodiment differs from the first embodiment in that aside from finger cover 420 of the glove 400 being woven of the conductive yarn 2, the body 410 is also woven of the conductive yarn 2, and the at finger cover 420 may be further integrally formed with the body 410 to form the glove 400. Therefore, any portion of the glove 400 disclosed in the second embodiment can be electrostatically coupled with the capacitive touch panel so that the operation of the capacitive touch panel can be accomplished in response to the user's touch.

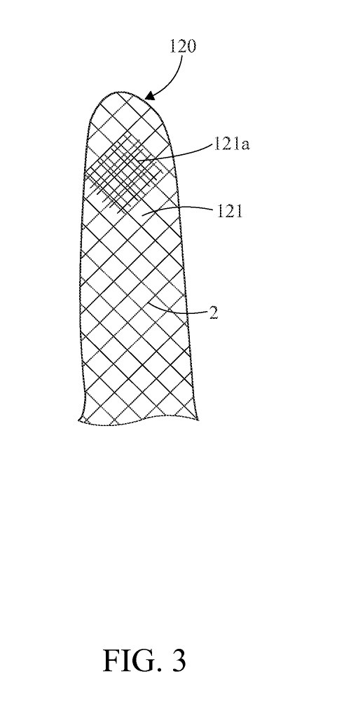

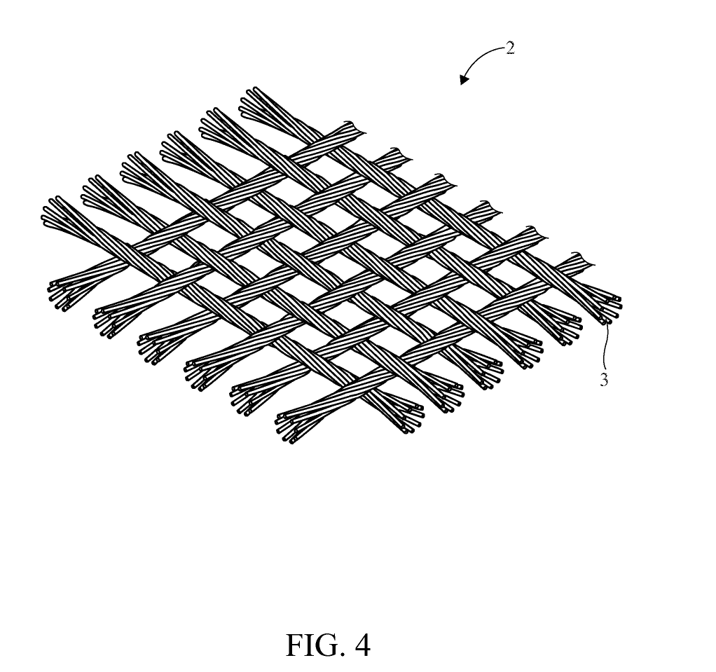

FIG. 3 is a schematic view of only a single finger cover 120 according to the first embodiment of the present invention. Because the finger cover 120 is separable from the body 110, the user may also wear only the finger cover 120 on a finger thereof to operate the touch panel without the use of the body 110. Furthermore, as may be readily known by those of ordinary skill in the art, the aforesaid conductive yarn 2 may also be used only in a fingertip portion 121a of the finger cover 120 to achieve the purpose of operating the touch panel. Next, in reference to FIG. 4, one strand of the conductive yarn 2 in the glove 100 and the glove 400 of the present invention is woven of a conductive material 3 so that the glove 100 and the glove 400 of the present invention can be electrostatically coupled with the capacitive touch panel. However, it can be readily appreciated by those of ordinary skill in the art that the present invention is not limited thereto, and it is also possible that more or all strands of the conductive yarn 2 are woven of the conductive material 3. Furthermore, the way in which the conductive material 3 is woven into the conductive yarn 2 may be at least either a plain weave, knitting, tatting, needle punching or combinations thereof. The conductive material 3 comprises at least one of the following so that the conductive material 3 can be electrostatically coupled with the capacitive touch panel: silver fibers, stainless steel fibers, carbon fibers, sputtered fibers or combinations thereof Moreover, the finger cover or the glove may also consist of one or more layers of conductive yarns or one or more layers of fabric different from the conductive yarn.

Of course, it can be readily appreciated by those of ordinary skill in the art that the conductive yarn 2 may also be disposed in either the finger pulp portion, the finger back portion of the finger cover or the fingertip portion of the finger pulp portion to reduce the manufacturing cost of the finger cover or glove of the present invention. Furthermore, the number of finger covers in the glove of the present invention may also vary depending on the user's requirements; for example, there may be only three or two finger covers, but the present invention is not merely limited thereto.

According to the above descriptions, selectively weaving the conductive yarn in either the finger pulp portion, the finger back portion, in the finger tip portion, throughout the whole finger covers, or in both the body and the finger covers of the glove can all allow the user wearing the finger cover or the glove of the present invention to operate the capacitive touch panel. This overcomes the shortcoming of the prior art in which it is not possible to give an instruction to the capacitive touch panel when the user wears a conventional finger cover or glove.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A glove for operating a capacitive touch panel, comprising:
a body; and
at least one finger cover having a finger pulp portion and a finger back portion opposite the finger pulp portion, and the at least one finger cover is separably combined with the body;
wherein the at least one finger cover is woven of a conductive yarn, and a user wearing the glove is able to be coupled with the capacitive touch panel through the at least one finger cover for touch control.

2. The glove as claimed in claim 1, wherein one or more strands of the conductive yarn are woven of a conductive material.

3. The glove as claimed in claim 2, wherein the conductive material comprises at least one of silver fibers, stainless steel fibers, carbon fibers, sputtered fibers and combinations thereof.

4. The glove as claimed in claim 1, wherein the weaving method of the conductive yarn comprises at least one of plain weave, knitting, tatting, needle punching and combinations thereof.

5. The glove as claimed in claim 1, wherein one of the finger pulp portion and the finger back portion of the at least one finger cover is woven of the conductive yarn.

6. The glove as claimed in claim 1, wherein both of the finger pulp portion and the finger back portion of the at least one finger cover are woven of the conductive yarn.

7. The glove as claimed in claim 1, wherein the body is woven of the conductive yarn.

8. The glove as claimed in claim 1, wherein the body is woven of a fabric different from the conductive yarn.

9. The glove as claimed in claim 1, wherein the at least one finger cover is formed integrally with the body.

10. The glove as claimed in claim 1, wherein the body and the at least one finger cover consist of one or more layers of conductive yarns.

11. The glove as claimed in claim 1, wherein the body and the at least one finger cover consist of one or more fabric layers different from the conductive yarn.

12. A finger cover for operating a capacitive touch panel, the finger cover being adapted to be separately combined with a body to form a glove, the finger cover comprising:
a finger pulp portion;
a finger back portion opposite the finger pulp portion;
wherein a portion of the finger cover is woven of a conductive yarn, and a user is able to be coupled with the capacitive touch panel through the finger cover for touch control.

13. The finger cover as claimed in claim 12, wherein one of the finger pulp portion and the finger back portion is woven of the conductive yarn.

14. The finger cover as claimed in claim 12, wherein the finger pulp portion further comprises a finger tip portion, the finger tip portion is woven of the conductive yarn.
